(19) United States
(12) Patent Application Publication
(10) Pub. No.: US 2015/0368068 A1
(43) Pub. Date: Dec. 24, 2015

(54) COMPENSATION ELEMENT WITH BLOCKING DEVICE

(71) Applicant: INVENTIO AG, Hergiswil (CH)

(72) Inventor: Heinz WIDMER, Rotkreuz (CH)

(21) Appl. No.: 14/765,577

(22) PCT Filed: Jan. 31, 2014
(86) PCT No.: PCT/EP2014/051881

§ 371 Date: Aug. 4, 2015

(30) Foreign Application Priority Data
Feb. 4, 2013 (EP) 13153798.7

(51) Int. Cl. B66B 7/06

(52) U.S. Cl. CPC B66B 7/068

(57) ABSTRACT

An elevator installation has a vertical elevator shaft, an elevator car vertically displaceable in a vertical direction in the shaft, a load-bearing device connected to the car and guided to a counterweight via a drive pulley, and a compensation element connected to the car and guided to the counterweight. A blocking device selectively secures the compensation element in the elevator installation such that, with the compensation element secured between the car and the blocking device, a tensioning force can be generated in the compensation element. The blocking device is used in a method for positioning the car in a desired position in the elevator installation.

### FIELD

The invention relates to an elevator installation as well as to a method for positioning an elevator car in a desired position in an elevator installation.

### BACKGROUND

In elevator installations with vertically movable cars a resilient support means, which is constructed as, for example, a support cable or support belt, is stretched or relieved between a blocked drive pulley of a drive means and the elevator car through loading/unloading of the elevator car. In that case, particularly in the case of high elevator installations, the problem can arise that an undesired offset in height (step) arises between a building floor and walk surface of the elevator car due to loading or unloading. This is particularly so in the lower floors when the section of the support means between drive means and the elevator car is comparatively long. There is therefore a need to provide compensation for this undesired offset in height.

Known systems for compensation for offset in height comprise, for example, load sensors which measure current loading of the elevator car. In addition a current position of the elevator car is determined by means of position sensors. The elevator drive is so controlled by an elevator control of the elevator drive from the thus-obtained data that the elevator car is moved to a desired position in which compensation is largely provided for the undesired offset in height. A system of that kind is described in, for example, WO 2005/102897. Further systems relate to compensation for offset in height by vertical displacement of the drive means itself or of the drive pulley of the drive means, such as described in, for example, DE 3903053.

Systems of that kind are on the one hand cost-intensive and maintenance-Intensive, since a multiplicity of sensors or a complicated drive suspension is required. In addition, systems in which the compensation for offset in height takes place only by way of the drive means have the disadvantage that due to the large support means lengths there can be a significant delay in time between actuation of the drive and resulting movement of the elevator car. Moreover, these systems have a high level of energy consumption due to constant compensation for the offset in height. Frequently repeated re-regulations of that kind also cause a shortened service life of components of the elevator installation, for example of the elevator drive.

In order to compensate for the weight of the support means, which due to the movement in opposite sense of elevator car and counterweight in the elevator shaft displaces in dependence on the position of the elevator car and the counterweight, on the side of the elevator car and the counterweight, a compensation element connected with the elevator car and the counterweight is provided at the elevator installation. The compensation element is so arranged that equalization of or compensation for the weight displacement of the support means is provided by the compensation element acting in opposite sense.

EP-B1-2289831 describes an elevator installation of that kind with a compensation element. The compensation element is guided by way of a compensation-element pulley below the region in which the elevator car is movable in the elevator shaft. The compensation-element pulley is displaceable in vertical direction by way of an actuator so that the elevator car can be drawn downwardly by way of the compensation element to provide compensation for a reduction in weight. In that case, a current position of the elevator car is determined by position sensors and adapted in vertical direction by continuous displacement of the compensation-element pulley. This system similarly has the disadvantage of a complicated construction and a complicated control. Moreover, compensation can be provided in this way only for unloading of the elevator car.

### SUMMARY

It is therefore an object of the invention to provide an elevator installation with an elevator car, as well as a method for positioning an elevator car in the elevator installation, which is constructionally simple to realize and capable of versatile use. In that case, an offset in height between a predetermined vertical height and a walk surface of the elevator car due to stretching of the length of the support means, particularly also in the case of different loads, shall be as small as possible.

The invention relates to an elevator installation with an elevator shaft and an elevator car, which is movable in vertical direction in the elevator shaft, a support means, which is connected with the elevator car and guided to a counterweight by way of drive means, and a compensation element, which is connected with the elevator car and guided to the counterweight. The compensation element is preferably fixed to the elevator car. The invention is distinguished by the fact that a blocking device is present by which the compensation element is so fixable in the elevator installation that when the compensation element is fixed a tensioning force can be generated in the compensation element between the elevator car and the blocking device.

The drive means typically comprises, apart from a drive motor, a drive pulley by way of which the support means is guided. As a rule, drive pulleys of that kind are constructed to be able to blocked, wherein the support means in the case of a blocked drive pulley is guided in slip-free manner by way of the drive pulley. In other words, the support means is usually blocked at the drive pulley when this is blocked.

The compensation element is, for example, constructed as a compensation cable or compensation belt and extends from the elevator car downwardly into a region of the shaft base and from there upwardly again to the counterweight. Equally conceivable are embodiments as compensation chains. The compensation element can be guided in the shaft base around a compensation-element pulley which can be constructed as, for example, a deflecting roller mounted at the shaft base.

The blocking device according to the invention allows fixing of the compensation element in the elevator installation. In that case, the fixing can take place with respect to a stationary or a movable component of the elevator installation. It will be obvious that the fixing of the compensation element can take place selectably, i.e. the blocking device can be constructed for the purpose of fixing the compensation element and releasing it again.

According to the Invention the blocking device is so constructed and so arranged in the elevator installation that when the compensation element is fixed a tensioning force can be generated in the compensation element between the elevator car and the blocking device. In other words, a bias which acts between the elevator car and the blocking device can be generated in the compensation element. In that case, the blocking device makes it possible to define an exact section of the compensation element between blocking device and elevator car in which the tensioning force can be generated.

Compensation element, elevator car and blocking device are so arranged relative to one another that the tensioning force in the compensation element generates a traction force on the elevator car in downward direction. The tensioning force in the compensation element, which acts on the elevator car, in that case corresponds with a virtual laden mass which increases on deflection of the elevator car in upward direction and decreases on deflection in downward direction. In this way at least partial compensation is provided for an actual laden (unladen) mass on the basis of the associated displacement of the elevator car, whereby overall a vertical displacement of the elevator car is smaller than would be the case due to the actually laden (unladen) mass and the elongation or shortening resulting therefrom of the section of the resilient support means without biasing in the compensation element. In this way, an undesired offset in height can be kept comparatively small. The greater the ratio k_{K}/k_{T} between the spring constant of the compensation element k_{K} and the spring constant of the support means k_{T} the smaller the resulting deflection, i.e. the better the compensation.

The tensioning force in the compensation element when the compensation element is fixed is preferably generated by a relative change in the spacing between the blocking device and the elevator car. This can be achieved, for example, by moving the elevator car when the blocking device is arranged to be stationary or, for example, by a blocking device movable in vertical direction. In variants, the blocking device can also be coupled with a separate drive, by which when the blocking device is arranged to be stationary a traction force can be produced by this on the fixed compensation element, for example by way of an additional blockable drive pulley about which the compensation element is guided.

With advantage, the compensation element is constructed as a compensation cable or compensation belt. In order to be able to generate a suitable tensioning force in the compensation element embodiments are preferred in which in simple manner a desired spring constant or resilience can be provided.

In a preferred form of embodiment the blocking device and the compensation element are so constructed and so arranged in the elevator installation that a section of the compensation element between the blocking device and the elevator car runs freely in the elevator installation. In that case, “free” denotes that the compensation element is not supported in the section between blocking device and elevator car at any other component of the elevator installation such as, for example, a deflecting roller. This has the advantage that an anticipated stretching of length in this distance due to the tensioning force which can be generated can be predicted in simple manner with a high level of accuracy.

In a preferred form of embodiment the blocking device is arranged in stationary position in the elevator installation and comprises at least one brake jaw which, for fixing the compensation element, acts directly on the compensation element. This has the advantage that the compensation element is fixable with respect to the elevator installation and thus a tensioning force, which acts on the elevator car and by this on the compensation element, can be produced in the support means by way of the drive means. In this way, the tensioning force can be produced in the compensation element by the drive means of the elevator installation.

The brake jaw preferably has a large dimension in the direction of the compensation element so as to avoid compressing the compensation element. Suitable dimensions depend on, for example, the construction of the compensation element and are immediately evident to the expert.

With advantage, the compensation element is guided by way of a compensation-element pulley and the blocking device is so constructed and so arranged in the elevator installation that the compensation element is fixable for any position of the elevator car in a section between the compensation-element pulley and the elevator car. As a rule, the compensation-element pulley is constructed as a deflecting roller in the region of the shaft base so that in this case the compensation element is fixable in a vertical region between deflecting roller and a lowermost position of the elevator car by the blocking device. In this way, the blocking device can be arranged in different positions matched to the circumstances of the elevator installation, which is advantageous in the case of, for example, retrofitting existing elevator installations with a blocking device of that kind.

Depending on requirements, the compensation element is, similarly with advantage, guided by way of a compensation-element pulley and the blocking device is so constructed and so arranged in the elevator installation that the compensation element is fixable to the compensation-element pulley. The blocking device can be constructed as, for example, at least one brake jaw which can be pressed against the compensation-element pulley in order to firmly clamp the compensation element to this compensation-element pulley.

In a preferred form of embodiment the compensation-element pulley itself is, however, constructed to be fixable as part of the blocking device, in which case the compensation element is guided in slip-free manner, particularly several times, around the compensation-element pulley. In this way it is possible to create, in constructionally simple manner, a blocking device which uses the compensation-element pulley which in a given case is present anyway. In addition, in this case the blocking device has to act only on the compensation-element pulley, which can similarly offer constructional advantages.

The blocking device is preferably arranged in stationary position in the elevator installation. Depending on the respective requirements, however, a form of embodiment can also be preferred in which the blocking device is, for generation of the tensioning force in the compensation element, arranged in the elevator installation to be movable, particularly in vertical direction, along the elevator shaft. In this instance, the tensioning force can be generated in the compensation element by the movement of the blocking device without a traction force having to be generated in the support means by the drive means. In this case it is sufficient if the support means is fixed at, for example, the drive means or at a further blocking device, i.e. blocked. The blocking device can in that case be constructed as, for example, a separate brake device, which is movable in the elevator shaft preferably in vertical direction, with a brake jaw for the compensation element. However, an embodiment is preferred in this case in which the compensation-element pulley forms a part of the blocking device. In this instance, the entire blocking device can be arranged to be movable, preferably in vertical direction, in the region of the shaft base, for example by way of a hydraulic device.

The invention additionally relates to a method for positioning an elevator car in a target position in an elevator installation, particularly in an elevator installation as described in the foregoing, comprising an elevator shaft in which the elevator car is movable, wherein the elevator shaft is preferably arranged to be vertical and the elevator car is movable in vertical direction, as well as a support means which is connected with the elevator car and is led by way of drive means to a counterweight. Moreover, the elevator installation comprises a compensation element which is connected with the elevator shaft and is led to the counterweight, as well as a blocking device by which the compensation element is so fixable in the elevator installation that when the compensation element is fixed a tensioning force can be generated in the compensation element between the elevator car and the blocking device. The method is distinguished by the following steps:
fixing the compensation element by means of the blocking device and
generating a tensioning force in the compensation element between the elevator car and the blocking device.

The compensation element is preferably fixed to the compensation device.

In that regard, denoted as target position is a vertical position of the elevator car in which the walk surface of the elevator car is substantially aligned with the level of the building floor. In other words, in the target position a largely stepless transition, i.e. largely without offset in height, between the walk surface of the elevator car and a floor, which can be walked on, of the building is guaranteed. The advantages of the method according to the invention are immediately evident from the description of the elevator installation according to the invention.

For preference, in the target position of the elevator car the tensioning force generated in the compensation element is so dimensioned that in all permissible load states of the elevator car, particularly without adjustment of the tensioning force, at least one residual tensioning force remains in the compensation element. The states here denoted as permissible load states refer to a permissible maximum load which can be conveyed by the elevator car. These load states are, for example, specific to the elevator installation and can differ from case to case. Due to the fact that a residual tension is provided for permissible load states it is prevented that the compensation element in the section between the blocking device and the elevator car can sag when it is fixed by the blocking device.

Advantageously, fixing of the compensation element by the blocking device takes place when the elevator car is disposed in an intermediate position different from the target position. In this case the elevator car can, when the tensioning force is generated, be positioned from the intermediate position into the target position.

In that regard, “intermediate position” can denote not just a stopping position in which the elevator car is initially stopped before the tensioning force is generated and the elevator car is positioned into the target position. The intermediate position can, however, equally be an Instantaneous travel position in which the compensation element is fixed by the blocking device, for example also subject to continuous braking, before the target position is reached. When the target position is reached the generated tensioning force can correspond with a predetermined or desired bias.

The tensioning force in the compensation element is preferably generated, in particular solely, by the elevator car being positioned by way of the support means from the Intermediate position into the target position through, in particular, the drive means of the elevator installation. This is of advantage particularly in the case of blocking devices arranged in stationary position in the elevator installation, but nevertheless is not restricted to these blocking devices arranged in stationary position in the elevator car.

In an optional equally preferred form of embodiment the tensioning force in the compensation element is generated, particularly solely, by the elevator car being positioned from the intermediate position into the target position by way of the compensation means, particularly through relative displacement of the blocking device with respect to the elevator car. Equally conceivable are forms of embodiment in which a tension force is exerted simultaneously not only by way of the support means, but also by the blocking device via the compensation element.

With advantage, the Intermediate position differs from the target position by a vertical distance d, which is defined as:

$$d = \vert \frac{( GQ - GQT ) * g * {L}_{u}}{{k}_{0}} \vert$$

In that case, GQ represents the maximum permissible load by which the elevator car may be loaded. GQT is the load by which the elevator car is currently loaded and Lᵤ denotes the length of the compensation element between the elevator car and the blocking device. Gravitational acceleration is denoted by g. k₀ is defined as k₀=E*A*f, wherein E is the modulus of elasticity, A the cross-section and f a degree of filling of the cross-section of the compensation element, which is constructed as, in particular, a compensation cable or compensation belt or compensation chain.

In this way it is ensured that when the target position is reached the desired tensioning force is generated in the compensation element. In this case, in the compensation-element section between the blocking device and the elevator car this is (GQ−GQT)*g.

For preference, the tensioning force in the compensation element is reduced, particularly to zero, prior to release of the compensation element, which is fixed by the blocking device, for movement of the elevator car in a transport journey. In that regard, “transport journey” denotes a journey of the elevator car serving for transport of goods or people. The transport journey is thus to be distinguished from a levelling journey such as takes place, for example, when positioning the elevator car from the Intermediate position into the target position. Due to the fact that prior to release of the compensation element, which is fixed by the blocking device, for a transport journey the tensioning force in the compensation element is reduced, particularly to zero, it is prevented that on release a residual tensioning force acts on the elevator car and this is moved abruptly or ‘Jumps’. The reduction in the tensioning force can in that case be carried out in reverse manner to the described generation of the tensioning force, i.e., for example, by way of the drive means and/or by way of a movable blocking device.

In order to not unnecessarily load the elevator components, particularly, for example, the compensation element or the support means, the movement for positioning of an elevator car in a target position can be carried out only in the case of load journeys. These can, for example, be selectively activated by a user. A method for operating the elevator installation described here therefore comprises the step of selectable activation or deactivation of the movement, which is described here, for positioning an elevator car into a target position.

### DESCRIPTION OF THE DRAWINGS

The Invention is explained in more detail in the following by way of exemplifying embodiments, in which:

FIG. 1 shows, schematically, an elevator installation with a blocking device;

FIGS. 2a-2c show, schematically, the positioning of the elevator car of the elevator installation according to FIG. 1 into a target position;

FIGS. 3a-3c show, schematically, the loading of the elevator car in the target position according to FIG. 2c;

FIGS. 4a-4c show, schematically, the positioning of the loaded elevator car into the target position;

FIGS. 5a-5c show, schematically, the unloading of the elevator car in the target position according to FIG. 4c; and

FIGS. 6a and 6b show, schematically, the positioning of an elevator car of a further form of embodiment of an elevator installation into a target position.

In principle, elements corresponding with one another are provided with the same reference numerals.

### DETAILED DESCRIPTION

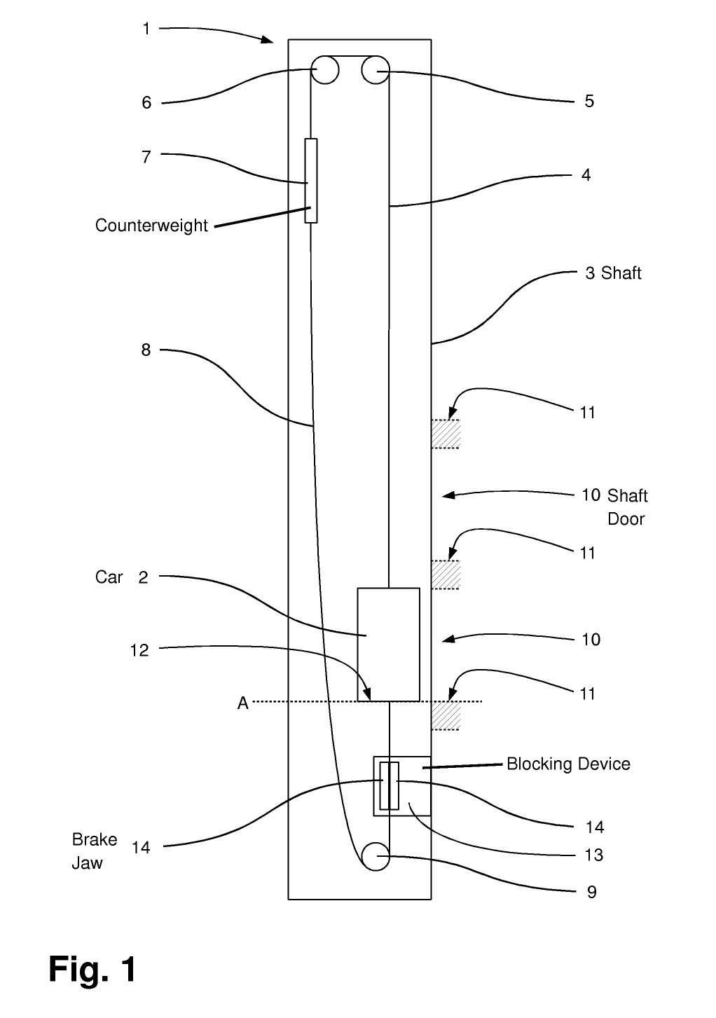

FIG. 1 shows an elevator installation 1 with an elevator car 2 in a vertical elevator shaft 3. The elevator car 2 is supported by a support means constructed as a support cable 4 and anchored to the elevator car 2. The support cable 4 is guided in the shaft head by way of a drive pulley 5 of a drive plant of the elevator installation 1. From the drive pulley 5 the support cable 4 is led by way of a deflecting roller 6 to a counterweight 7 and anchored at this. The elevator car 2 is movable in vertical direction in the elevator shaft 3 by the drive plant by way of the support cable 4.

A compensation element constructed as a compensation cable 8 extends from the elevator car 2 to the counterweight 7 and is anchored at this. The compensation cable 8 in that case extends from the counterweight 7 in the elevator shaft 3 downwardly and is guided in the shaft base by way of a compensation-element pulley constructed as a deflecting roller 9. In the further course, the compensation cable 8 is led upwardly to the elevator car 2 and anchored thereat. The compensation cable 8 compensates for the weight of the support cable 4, which as a consequence of the movement of the elevator car 2 and counterweight 7 in opposite sense in the elevator shaft 3 displaces between the side of the elevator car 2 and of the counterweight 7.

A plurality of shaft doors 10 is constructed in the elevator shaft 3 at different floors. A floor level is in the present instance defined as the vertical height of a surface, which can be walked on, of the floor. If the elevator car 2 is disposed in a position, which is denoted as target position A, at one of the shaft doors 10 then a walk surface 12 of the elevator car 2 is arranged at the substantially same vertical height as the corresponding floor level 11. It will be obvious that target position A can also denote any other desired position into which the elevator car 2 can be moved as accurately as possible.

A blocking device 13 is arranged in stationary position in the elevator shaft 3 below the travel region of the elevator car 2. The blocking device 13 comprises brake jaws 14, between which the compensation cable 8 runs. The compensation cable 8 can be fixed in the region of the blocking device 13 with respect to the elevator installation 1 by the blocking device 13.

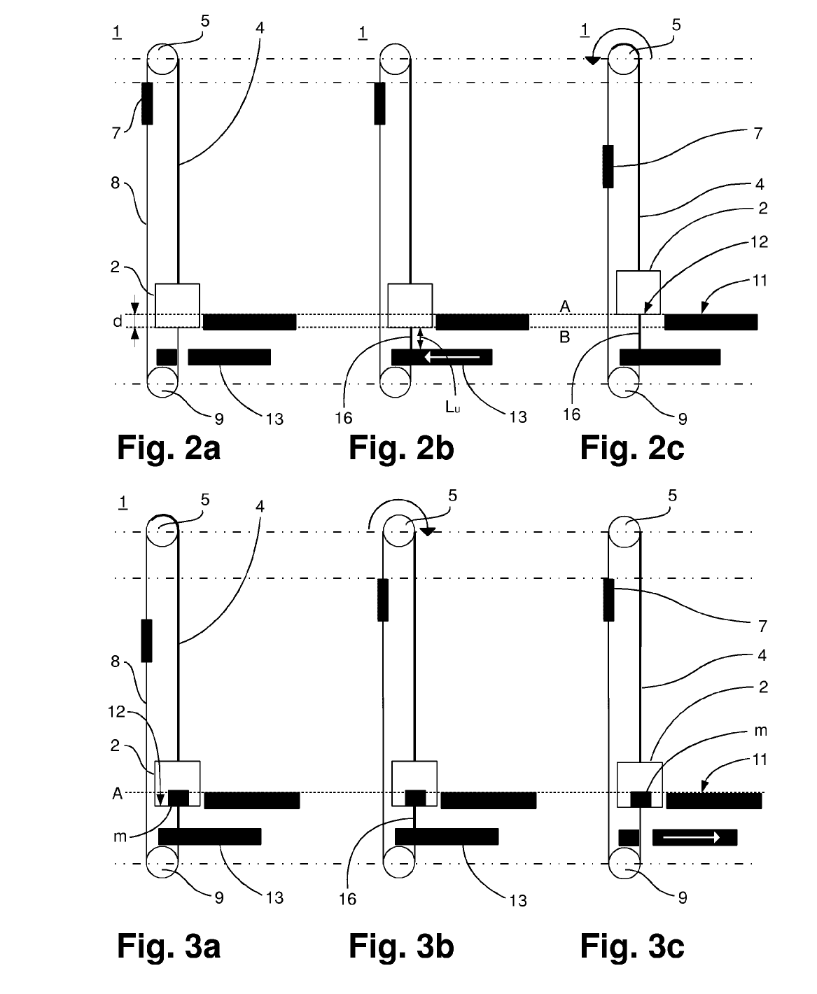

FIGS. 2a-2c show the positioning of the elevator car 2 in the target position A, when the elevator car 2 is empty, in the elevator installation 1. The elevator car 2 is initially moved to an intermediate position B in which the walk surface 12 is arranged below the floor level 11 by a vertical distance d (FIG. 2a). The compensation element 8 is in that case freed by the blocking device 13, i.e. Is not fixed by this.

The distance d is preferably calculated in accordance with the formula

$$d = \vert \frac{( GQ - GQT ) * g * {L}_{u}}{{k}_{0}} \vert$$

In that case, GQ represents the maximum permissible load by which the elevator car 2 may be loaded. GQT is the load by which the elevator car 2 is currently loaded (in FIGS. 2a-2c thus equal to zero) and Lᵤ denotes the length of the compensation cable 8 between the elevator car 2 and the blocking device 8.

Gravitational acceleration is denoted by g. k₀ is defined as k₀=E*A*f, wherein E is the modulus of elasticity, A is the cross-section and f is a degree of filling of the cross-section of the compensation cable 8.

If the elevator car 2 is disposed in the intermediate position B, the compensation cable 8 is fixed by the blocking device 13 (FIG. 2b). In this way, a compensation-cable section 16 is defined between the elevator car 2 and the blocking device 13.

Consequently, a tensioning force is generated in the support cable 4 by way of the drive pulley 5 of the elevator drive, i.e. the drive pulley 5 drives the support cable 4 analogously to a transport journey of the elevator car 2 in upward direction, until the elevator car 2 has moved by the vertical distance d from the intermediate position B to the target position A (levelling journey). In the target position A, the walk surface 12 is arranged at the same vertical height as the floor level 11 (see FIG. 2c). The support cable 4 and the compensation cable 8 are in that case biased in the region between blocking device 13 and drive pulley 5. In particular, the compensation cable 8 in the compensation-cable section 16 between the blocking device 13 and the elevator car 2 is biased by the thus-generated tensioning force.

Inasmuch as the vertical distance d between target position A and intermediate position B is selected as described above it is ensured that not only when the elevator car 2 is empty, but also when the elevator car 2 is loaded with maximum load a sufficient tensioning force is available in the compensation-cable section 16.

FIGS. 3a-3c show loading of the empty elevator car 2 when this is disposed in the target position A (see also FIG. 2c) and the initiation of a transport journey of the laden elevator car 2. Through loading of the elevator car 2 with a mass m, the elevator car 2 is deflected downwardly from the target position A (see FIG. 3a). In that case, the tensioning force in the compensation-cable section 16 between blocking device 13 and elevator car 2 reduces with increasing deflection of the elevator car 2 in downward direction. The elevator car 2 comes to rest when the sum of the gravitational force of the laden mass m and the reduced tensioning force corresponds with the original tensioning force in the compensation-cable section 16 when the empty elevator car 2 is in the target position A. The tensioning force in the support cable 4 in that case does not significantly change, i.e. the tensioning force in the support cable 4 changes significantly less than if the method described here were not to be employed. The deflection of the elevator car 2 in downward direction is thus smaller than would be the case without the tensioning force, which acts by the compensation cable 8, due to the laden mass m.

In order to initiate a transport journey of the laden elevator car 2, for example to another floor, the tensioning force in the compensation-cable section 16 is reduced. This takes place by way of the drive pulley 5 of the elevator drive, i.e. the drive pulley 5 drives the support cable 4 analogously to a transport journey of the elevator car 2 in downward direction until the tensioning force is substantially reduced to zero. This means that the drive pulley 5 enables a controlled relaxation of the support cable 4. Only then is the blocking device 13 released (see FIG. 3c) and the compensation cable 8 freed. The elevator car 2 can now move to a different target position, for example to another floor.

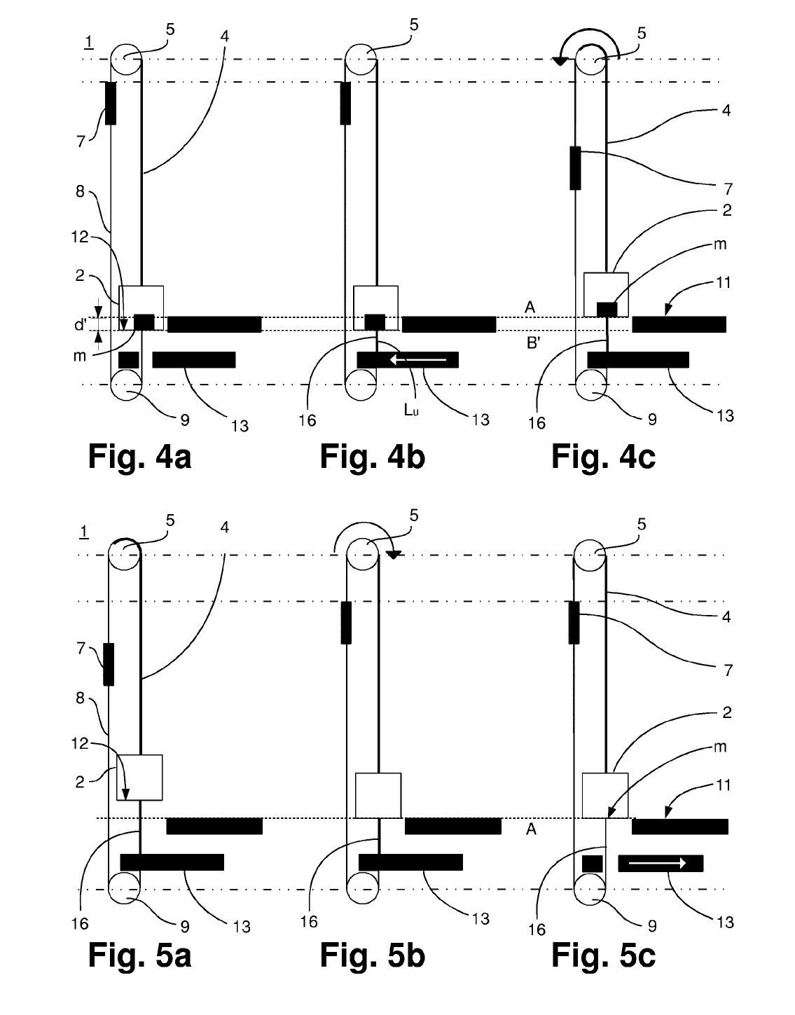

FIGS. 4a-4c show movement to the target position A in the case of an elevator car 2, which is loaded with a mass m, in the elevator installation 1. The elevator car 2 is moved to an intermediate position B′ In which the walk surface 12 is arranged below the floor level 11 by a vertical distance d′ (FIG. 4a). In that case, d′ arises in accordance with the above-mentioned formula, wherein in this instance the laden mass is different from zero, i.e. in the present instance GQT=m. The further steps of fixing of the compensation cable 8 (see FIG. 4b) as well as the levelling journey to the target position A (see FIG. 4c) take place analogously to the unladen state of the elevator car 2 (see FIGS. 2b and 2c).

FIGS. 5a-5c show unloading of the elevator car 2 loaded with m, when this is disposed in the target position A (see also FIG. 4c) and initiation of a transport journey of the unladen elevator car 2. Through unloading of the mass m the elevator car 2 is deflected upwardly out of the target position A (see FIG. 5a). In that case, the tensioning force in the compensation-cable section 16 between the blocking device 13 and the elevator car 2 increases with increasing deflection of the elevator car 2 in upward direction. The elevator car 2 comes to rest when the sum of the gravitational force of the empty elevator car 2 and the increased tensioning force corresponds with the original tensioning force in the compensation-cable section 16 with laden elevator car 2 in the target position A. The tensioning force in the support cable 4 does not change in that case. The deflection of the elevator car 2 in upward direction is thus less than would be the case without the tensioning force, which acts with the compensation cable, due to the unloaded mass m.

In order to initiate a transport journey of the unladen elevator car 2, for example to another floor, the tensioning force is reduced in the compensation-cable section 16 analogously to the loaded case (see FIG. 5b, analogous to FIG. 3b) and the compensation cable 8 is freed (see FIG. 5c, analogous to FIG. 3c). The empty elevator car 2, after reduction of the tensioning force, is again disposed in the target position A.

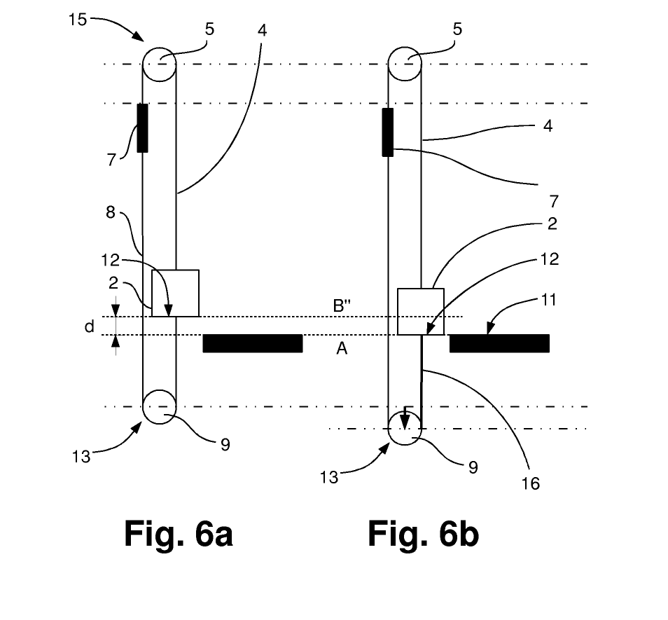

FIGS. 6a and 6b show positioning of the elevator car 2 into the target position A with empty elevator car in a further form of embodiment of an elevator installation 15. By contrast to the elevator installation 1, the deflecting roller 9 is arranged in the elevator installation 15 to be displaceable in vertical direction. The deflecting roller 9 is so constructed as part of the blocking device 13 that the compensation cable 8 is fixable thereto. The vertical displacement takes place by way of, for example, a hydraulic device (not illustrated).

The elevator car 2 is initially moved to an intermediate position B″ in which the walk surface 12 is arranged above the floor level 11 by a vertical distance d (FIG. 6a). The distance d is also calculated in this case in accordance with the above formula. The compensation element 8 is then guided around the freely rotating deflecting roller 9. As a consequence, the compensation cable 8 is fixed to the deflecting roller 9 and this is moved downwardly (see FIG. 6b). In that case, a tensioning force is generated between the support cable 4, which is fixed to the drive pulley 5, and the deflecting roller 9. In particular, the bias is generated in the compensation-cable section 16 between deflecting roller 9 and elevator car 2. The procedure for loading and unloading of the elevator car 2 as well as initiation of a transport journey of the elevator car 2 of the elevator installation 15 will be immediately obvious from the description of the elevator installation 1.

In accordance with the provisions of the patent statutes, the present invention has been described in what is considered to represent its preferred embodiment.

However, it should be noted that the invention can be practiced otherwise than as specifically illustrated and described without departing from its spirit or scope.

1-16. (canceled)

17. An elevator installation, comprising:
an elevator shaft;
an elevator car movable in the elevator shaft;
a support device connected between the elevator car and a counterweight and led over a drive pulley;
a compensation element connected between the elevator car and the counterweight; and
a blocking device for selectively fixing the compensation element in the elevator shaft wherein when the compensation element is fixed by the blocking device a tensioning force can be generated in a section of the compensation element between the elevator car and the blocking device by relative movement between the elevator car and the blocking device.

18. The elevator installation according to claim 17 wherein the tensioning force in the section of the compensation element is generated, when the compensation element is fixed, by a relative change in spacing between the blocking device and the elevator car.

19. The elevator installation according to claim 17 wherein the compensation element is formed as a compensation cable or a compensation belt.

20. The elevator installation according to claim 17 wherein the section of the compensation element extends freely in the elevator shaft between the blocking device and the elevator car.

21. The elevator installation according to claim 17 wherein the blocking device is arranged in a stationary position in the elevator shaft and Includes at least one brake jaw for fixing the compensation element by acting directly on the compensation element.

22. The elevator installation according to claim 17 wherein the compensation element is guided by a compensation-element pulley and for any position of the elevator car in the elevator shaft the section of the compensation element is between the compensation-element pulley and the elevator car.

23. The elevator installation according to claim 17 wherein the compensation element is guided by a compensation-element pulley and the blocking device fixes the compensation element to the compensation-element pulley.

24. The elevator installation according to claim 23 wherein the compensation-element pulley is displaceable in a vertical direction in the elevator shaft and the compensation element is guided in slip-free manner around the compensation-element pulley.

25. The elevator installation according to claim 17 wherein the blocking device is movable in a vertical direction in the elevator shaft for generation of the tensioning force in the compensation element.

26. A method for positioning an elevator car at a target position in an elevator installation, the elevator installation including an elevator shaft in which the elevator car is movable, a support device connected between the elevator car and a counterweight and guided by a drive pulley, a compensation element connected between the elevator car and the counterweight, and a blocking device for selectively fixing the compensation element in the elevator shaft, comprising the steps of:
fixing the compensation element with the blocking device; and
generating a tensioning force in a section of the compensation element between the elevator car and the blocking device by relative movement between the elevator car and the blocking device.

27. The method according to claim 26 wherein when the elevator car is at the target position, the tensioning force generated in the section of the compensation element is dimensioned in all permissible load states of the elevator car so that at least one residual tensioning force remains in the section of the compensation element.

28. The method according to claim 26 wherein the fixing of the compensation element is carried out when the elevator car is disposed in an Intermediate position different from the target position and the tensioning force is generated by moving the elevator car from the Intermediate position into the target position.

29. The method according to claim 28 wherein the tensioning force is generated by the elevator car being moved from the intermediate position into the target position by the support device driven by the drive pulley.

30. The method according to claim 28 wherein the tensioning force is generated by the elevator car being moved from the intermediate position into the target position by the compensation element through relative displacement of the blocking device with respect to the elevator car.

31. The method according to claim 28 wherein the intermediate position differs from the target position by a vertical distance d which is defined by the equation
$$d = \vert \frac{( GQ - GQT ) * g * {L}_{u}}{{k}_{0}} \vert$$
wherein GQ represents a maximum permissible load by which the elevator car may be loaded, GQT is a load by which the elevator car is currently loaded, Lᵤ is a length of the compensation element between the elevator car and the blocking device and k₀ is defined as k₀=E*A*f, wherein E is a modulus of elasticity, A is a cross-section and f is a degree of filling of the cross-section of the compensation element being constructed as a compensation cable or compensation belt.

32. The method according to claim 26 wherein prior to release of the compensation element from being fixed by the blocking device for movement of the elevator car in a transport journey the tensioning force in the compensation element is reduced.

33. The method according to claim 32 wherein the tensioning force in the compensation element is reduced to zero.

34. An elevator installation including an elevator shaft, an elevator car movable in the elevator shaft, a support device connected between the elevator car and a counterweight and led by a drive pulley, comprising:
a compensation element connected between the elevator car and the counterweight; and
a blocking device in the elevator shaft for selectively fixing the compensation element wherein when the compensation element is fixed by the blocking device a tensioning force can be generated in a section of the compensation element between the elevator car and the blocking device independent of a remainder of the compensation element by relative movement between the elevator car and the blocking device.
